(19) United States
(12) Patent Application Publication
(10) Pub. No.: US 2008/0307262 A1
(43) Pub. Date: Dec. 11, 2008

(54) System for Validating Data for Processing and Incorporation in a Report

(75) Inventor: James T. Carlin, III, Collegeville, PA (US)

Correspondence Address: SIEMENS CORPORATION;INTELLECTUAL PROPERTY DEPARTMENT, 170 WOOD AVENUE SOUTH, ISELIN, NJ, 08830, US

(73) Assignee: Siemens Medical Solutions USA, Inc., Malvern, PA (US)

(21) Appl. No.: 12/131,965

(22) Filed: Jun. 3, 2008

Related U.S. Application Data
(60) Provisional application No. 60/941,967, filed on Jun. 5, 2007.

(51) Int. Cl. G06F 11/00; G06F 17/30

(52) U.S. Cl. 714/37; 707/102; 714/E11.002; 707/E17.044

(57) ABSTRACT

A system automates the process of isolating incorrect, corrupt, or sensitive data and skipping duplicate records caused by violations of application business rules during report generation, for example. A data processor provides data for processing for incorporation in a report by, processing received report data to identify data objects in the report data likely to generate errors in preparation of a report based on the report data and providing validated report data by collating received report data and omitting identified data objects likely to generate errors. The data processor communicates the validated report data for storage in a repository for use in preparation of a report. An error data processor provides information indicating identified data objects in the report data likely to generate errors and a corresponding reason an individual data object is likely to cause an error.

This is a non-provisional application of provisional application Ser. No. 60/941,967 filed Jun. 5, 2007, by J. T. Carlin III.

### FIELD OF THE INVENTION

This invention concerns a system for validating data for processing and incorporation in a report by identifying data objects in report data likely to generate errors and corresponding reasons individual data objects are likely to cause errors.

### BACKGROUND OF THE INVENTION

Financial reporting software that utilizes data warehousing (fact and dimension tables), typically and regularly employ report processing components that may fail due to duplication of source data. An executable application used to provide source data may allow a person to have more than one current legal name and involve use of an executable procedure that loads data concerning unique persons into a fact table causing report processing components to fail, for example. In known systems, programming code is typically written to manage duplicate record data processing failures to determine what records are causing the problem. This may involve manually coding a statement to skip duplicate records and rerun or restart failed processing.

Business software that utilizes data warehousing may process reports regularly and generation of those reports may fail due to a variety of data errors. Often, such errors become visible during a data extraction process and may be indicative of malicious corruption of a database, but these errors may also be attributed to data entered from an external system. A data model used by an executable application may specify that a person can have only one government issued identifier and so identification of a person in the database using more than one identifier violates the data model. An Online Transaction Processing (OLTP) system may tolerate this violation, but the violation is detected by a reporting system using the database to generate reports. It is also possible for errors to go unnoticed for a period of time before negatively impacting a transaction processing system. Known systems either filter incorrect data before loading it into a reporting system, or load the incorrect information and react when report procedures fail due to incorrect data. In known systems, when a report generation procedure fails, a user typically needs to write database query code to determine what records are causing the problem. The user needs to manually edit a report procedure to bypass incorrect records, recompile a procedure, and rerun or restart the failed procedure. This is time consuming and burdensome and manual edits (to bypass the bad data) need to be applied in several different places within the report procedure, which is a task prone to further error. In addition, executable code logic used to skip records may be overwritten or lost when a next level of software is installed. This burdensome known system multi-step process involves identifying problems and isolating problems from a reporting database. A system according to invention principles addresses these deficiencies and related problems.

### SUMMARY OF THE INVENTION

A system automates the process of isolating incorrect, corrupt, or sensitive data as it is transferred from a transaction database to a reporting data base by automatically, applying integrity checking to an Extract, Transform and Load (ETL) function for moving data, skipping duplicate records caused by violations of application business rules and using a workflow supporting identification and correction of bad data. A system validates data for processing and incorporation in a report. A data processor provides data for processing for incorporation in a report by, processing received report data and identifying data objects in the report data likely to generate errors in preparation of a report based on the report data and providing validated report data by collating received report data and omitting identified data objects likely to generate errors. The data processor communicates the validated report data for storage in a repository for use in preparation of a report. An error data processor provides information indicating identified data objects in the report data likely to generate errors and a corresponding reason an individual data object is likely to cause an error.

### BRIEF DESCRIPTION OF THE DRAWING

FIG. 1 shows a system for validating data for processing and incorporation in a report, according to invention principles.

FIG. 2 shows a table listing error records generated during report generation, according to invention principles.

FIG. 3 shows a user interface display image for entering and presenting information identifying data objects causing report generation errors, according to invention principles.

FIG. 4 shows a user interface display image for searching information identifying data objects causing report generation errors, according to invention principles.

FIGS. 5 and 6 show processes for processing data objects causing report generation errors performed by a system for validating data for processing and incorporation in a report, according to invention principles.

FIG. 7-9 illustrate steps in processing data objects causing report generation errors performed by a system for validating data for processing and incorporation in a report, according to invention principles.

FIG. 10 shows a flowchart of a process performed by a system for validating data for processing and incorporation in a report, according to invention principles.

### DETAILED DESCRIPTION OF THE INVENTION

A system automates the process of isolating incorrect, corrupt, or sensitive data as it is transferred from an OnLine Transaction Processing (OLTP) operational database to an analytic reporting data base. The system performs data integrity checking while using an Extract, Transform, and Load (ETL) function for moving data from an operational database to a reporting database, for example. The data integrity checking includes, but is not limited to, parsing and examining data records to identify Incorrect records, Missing information, Corrupt data, data Ranges of values in particular data fields, Range checking on row and column counts, Referential integrity, Security and Privacy. The system automates the process of bypassing duplicate records caused by violations of application business rules in a batch report processing procedure, for example. It also supports a workflow to identify the bad data to a user and enables correction of the bad data. The system prevents failure of data record processing due to occurrence of duplicate records and provides a worklist report identifying duplicate records usable by an administrator to investigate and resolve duplicate record problems. Further, the system automates the process of filtering inappropriate records caused by corrupt data or violations of application business rules during data transfer from an OLTP system to a Data Warehouse, for example.

A processor as used herein is a device and/or set of machine-readable instructions for performing tasks. A processor comprises any one or combination of, hardware, firmware, and/or software. A processor acts upon information by manipulating, analyzing, modifying, converting or transmitting information for use by an executable procedure or an information device, and/or by routing the information to an output device. A processor may use or comprise the capabilities of a controller or microprocessor, for example. A processor may be electrically coupled to any other processor enabling interaction and/or communication there-between. A display processor or generator is a known element comprising electronic circuitry or software or a combination of both for generating display images or portions thereof. A user interface comprises one or more display images enabling user interaction with a processor or other device.

An executable application, as used herein, comprises code or machine readable instructions for conditioning the processor to implement predetermined functions, such as those of an operating system, a context data acquisition system or other information processing system, for example, in response to user command or input. An executable procedure is a segment of code or machine readable instruction, sub-routine, or other distinct section of code or portion of an executable application for performing one or more particular processes. These processes may include receiving input data and/or parameters, performing operations on received input data and/or performing functions in response to received input parameters, and providing resulting output data and/or parameters. A user interface (UI), as used herein, comprises one or more display images, generated by a display processor and enabling user interaction with a processor or other device and associated data acquisition and processing functions.

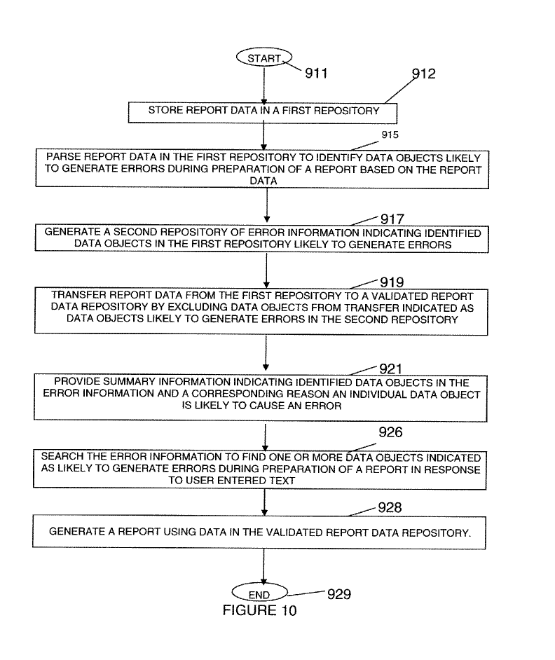

The UI also includes an executable procedure or executable application. The executable procedure or executable application conditions the display processor to generate signals representing the UI display images. These signals are supplied to a display device which displays the image for viewing by the user. The executable procedure or executable application further receives signals from user input devices, such as a keyboard, mouse, light pen, touch screen or any other means allowing a user to provide data to a processor. The processor, under control of an executable procedure or executable application, manipulates the UI display images in response to signals received from the input devices. In this way, the user interacts with the display image using the input devices, enabling user interaction with the processor or other device. The functions and process steps (e.g., of FIG. 10) herein may be performed automatically or wholly or partially in response to user command. An activity (including a step) performed automatically is performed in response to executable instruction or device operation without user direct initiation of the activity. Workflow comprises a sequence of tasks performed by a device or worker or both. An object or data object comprises a grouping of data, executable instructions or a combination of both or an executable procedure.

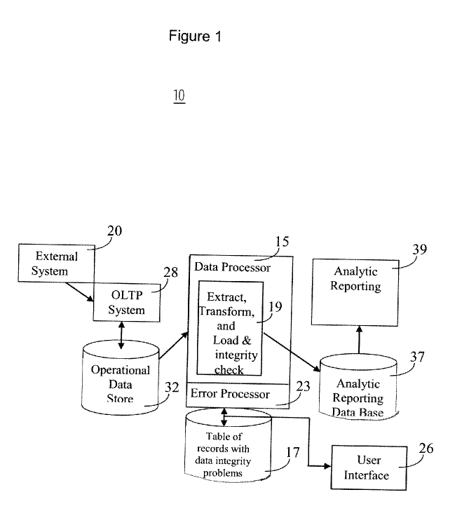

FIG. 1 shows system 10 for validating data for processing and incorporation in a report. Operational data store 32 includes data acquired from OLTP system 28 and from external systems 20 via OLTP system 28. Data processor 15 provides data for processing for incorporation in a report by, processing report data received from operational data store 32 to identify data objects in the report data likely to generate errors in preparation of a report based on the report data. Data processor 15 provides validated report data by collating received report data and omitting identified data objects likely to generate errors and communicates the validated report data for storage in a repository (analytic reporting database 37) for use in preparation of a report. Data processor 15 incorporates a corrupt data detection and report data validation function and operates in conjunction with, Extract, Transform, Load (ETL) executable procedures 19 that are used for parsing data records in operational data store 32. System 10 enables daily or nightly batch report processing, for example, to be completed without being hindered by corrupt data. The corrupt data does not need to be fixed in real time, allowing reporting database ETL procedure 19 to complete successfully. Error processor 23 generates a report or worklist identifying corrupt data for someone to investigate and resolve. System 10 identifies problems that may impact a transaction processing application. System 10 further supports a workflow (a task sequence) to identify bad data for automatic correction or for a user to manually correct. Error data processor 23 provides information for storage in repository 17 indicating identified data objects, in the report data, likely to generate errors and a corresponding reason an individual data object is likely to cause an error. Analytic report processor 39 processes record data in validated report data stored in analytic reporting database 37 to provide a user requested report.

User interface processor 26 initiates generation of data representing at least one display image supporting user access to as well as review and management of, identified data objects in report data likely to generate, or having generated, errors in a report in response to a report processing workflow. The at least one display image is presented on a workstation, for example. The system advantageously accelerates completion of daily or nightly report batch report processing with minimal or no manual intervention required to address processing of duplicate records that may cause an executable load procedure to fail, for example. A report or worklist is generated by error processor 23 identifying bypassed records in a fact table to be investigated and resolved by a user. The system expedites resolution or prevention of duplicate records in an application database.

System 10 in one embodiment includes a database table in repository 17 and a set of stored procedures. A database table (identified as smsdss.RptJobBypassObj and illustrated in Table I) has a row for individual data objects that are incorrect and are to be skipped, for example. Columns and attributes of the table indicate data object name (column_name), data object data type, object character length and whether a data object is nullable (i.e., may be set to zero or blank).

TABLE I

| Column name | Type | Length | Nullable |
|---|---|---|---|
| TrgTable | varchar | 254 | no |
| BypassObjId | bigint | 8 | no |
| PassSeqNo | tinyint | 1 | no |
| ErrBusStrDate | datetime | 8 | no |
| CharmNo | bigint | 8 | yes |
| EVTS | bigint | 8 | yes |
| RsnText | varchar | 254 | yes |
| RslvDate | datetime | 8 | yes |
| UserId | varchar | 254 | no |

Set of stored procedures 19 in data processor 15 automatically parses and analyzes data acquired from operational data store 32 using data validation rules to identify incorrect records and insert data indicating the incorrect records into the table exemplified in Table I. A user may also employ user interface 26 to manually enter data indicating incorrect records into the table. Data processor 15 employs a qualification advantageously added to source code comprising individual fact load stored procedures (fact load stored procedures load individual data items (facts)) that are associated with Table I in order to skip (bypass) the objects identified as incorrect. The qualification to the source code (in a “where clause”, for example) of individual fact load stored procedures may be illustrated as:

and (f.ObjId not in (select a.ByPassObjId from smsdss.RptJobBypassObj a where a.TrgTable=‘fact table object name’ and a.PassSeqNo=1 and a.RslvDate is null))
If duplicate data is detected and included in a smsdss.RptJobBypassObj table, this qualification reads the table and the data is bypassed during load of data by data processor 15 from operational data store 32. If duplicate data is not detected, this qualification is ignored during load.

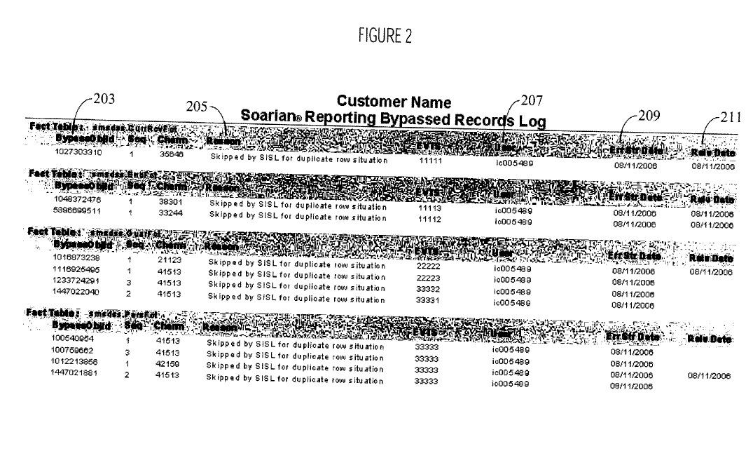

FIG. 2 shows a table listing error records generated by error processor 23 during report generation and stored in repository 17. The table of FIG. 2 comprises a worklist report that displays (by fact table) information indicating data objects that are being bypassed and other pertinent information. Specifically, the FIG. 2 table identifies data objects in column 203 that are bypassed as likely to cause errors during report generation and associated reasons why objects are bypassed in column 205. Column 207 identifies an associated user, and columns 209 and 211 identify error detection and resolution dates respectively.

The smsdss.RptJobBypassObj table (Table I) is an object that is created by data processor 15 and is delivered with reporting software, for example. In system 10 (FIG. 1) the table is automatically populated and/or manually populated by a user in response to detection of errors likely to cause report generation errors including the detection of duplicate data, for example. A user interface (e.g., derived by Java executable procedures) assists and prompts a user to enter data indicating detected errors such as detected duplicate data.

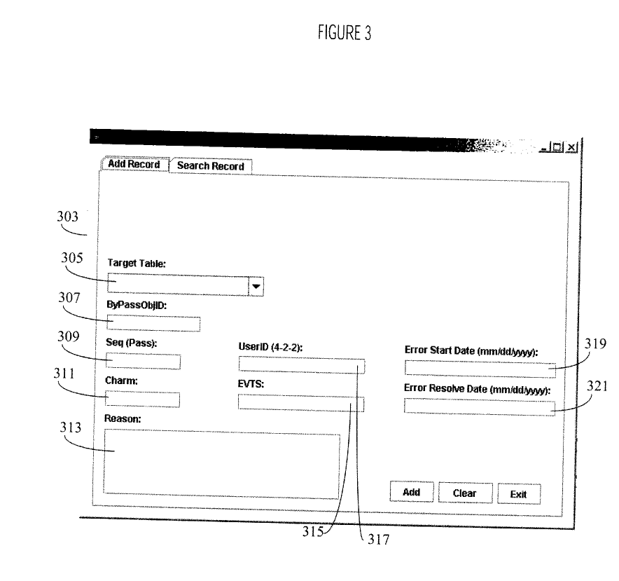

FIG. 3 shows user interface display image 303 for entering and presenting (manually entered or auto-populated) information identifying data objects causing report generation errors. As used herein duplicate data comprises any error in underlying report data likely to cause errors in generation of a report. Data indicating a Target Table is selected in box 305 from a drop down list of candidate fact tables individually containing duplicate data that may cause errors. Multiple ByPassObjIDs (e.g., up to 50 ObjIds entered at one time) are entered in box 307 comprising a list of duplicate ObjId's separated by a comma. A Seq number (sequence number or pass number) of a stored procedure (a fact table may be processed using up to 16 sequences or passes, for example) that identifies duplicate data, is entered or presented in box 309. A Charm number identifying a defect or change request created for duplicate data is entered or presented in box 311 and a UserID of support personnel entering information identifying duplicate data is entered or presented in box 317. An EVTS number (identifying a defect) created for duplicate data is entered or presented in box 315. The Charm and EVTS numbers are usable in a software defect error tracking system to track progress of defects and change requests, for example. An Error Start Date indicating a date that duplicate data is detected and an Error Resolution Date indicating a date that duplicate data is fixed (or deleted), is presented or entered in boxes 319 and 321 respectively. A Reason associated with the duplicate data, is entered or presented in free form text field box 313 in which a user can freely enter desired comments. (This may be automatically populated in another embodiment based on parsing of records to determine nature and type of duplicate records and their source, size, for example which is translated into a reason for population of a reason field).

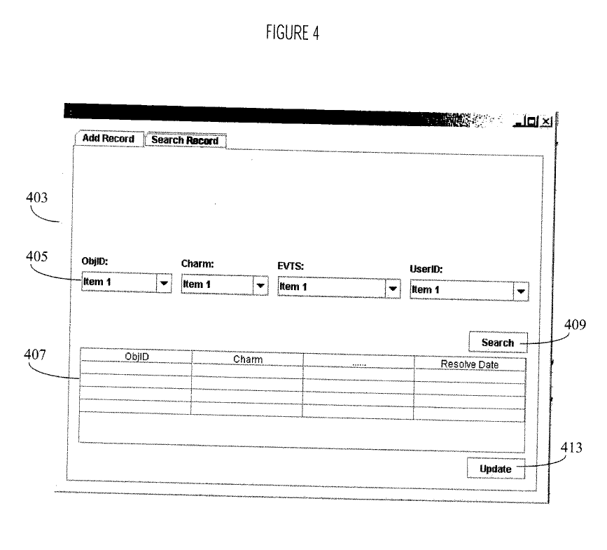

FIG. 4 shows user interface display image 403 for searching and editing information identifying data objects causing report generation errors. Specifically, user interface display image 403 allows a user to initiate a search, or update, using data processor 15 (FIG. 1), of any duplicate data that is identified in the smsdss.RptJobBypassObj table (Table I). A user may select search criteria comprising one or more of, Objid, Charm Number, EVTS number and Userid in row 405. Duplicate data identified in a search of the smsdss.RptJobBypassObj table (Table I), in response to user selection of button 409, is presented in window area 407. Data in window area may be edited and the table updated with the edited data in response to user selection of button 413.

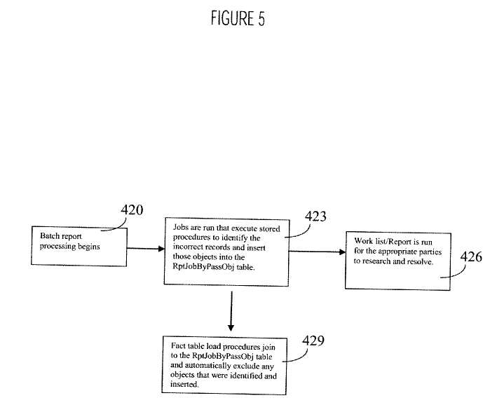

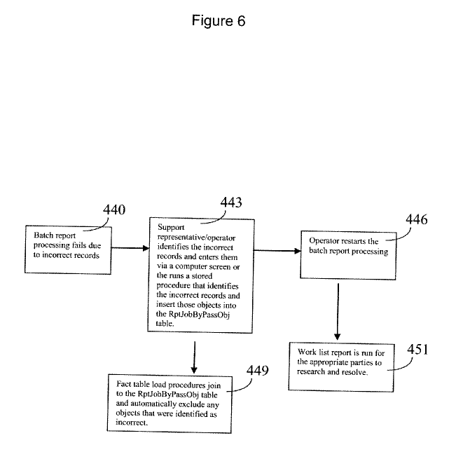

FIGS. 5 and 6 show flowcharts of processes for processing data objects causing report generation errors performed by system 10 (FIG. 1) for validating data for processing and incorporation in a report. In the process of FIG. 5 incorrect records are automatically bypassed, avoiding a need for manual intervention. A user manually reviews a generated error work list and resolves incorrect records. Data processor 15 in step 420 of FIG. 5 initiates batch report processing of report data acquired from operational data store 32. In step 423 batch report processing is performed by execution of stored executable procedures to identify incorrect records. Error processor 23 inserts data identifying incorrect records (data objects) in the smsdss.RptJobBypassObj table (e.g., Table I) in repository 17. In step 426 analytic report processor 39 processes record data in the smsdss.RptJobBypassObj table in repository 17 to provide a work list and report for one or more workers to investigate and resolve. Data processor 15 in step 429 employs a qualification advantageously added to source code comprising individual fact load stored procedures that are associated with the table in repository 17 and automatically excludes objects identified as incorrect in the table in repository 17 during load of report data from operational store 32.

In the process of FIG. 6 records are bypassed using manual intervention. In step 440 of FIG. 6 batch report processing of report data acquired from operational data store 32 fails. In step 443, a worker identifies incorrect records and enters data identifying the incorrect records via a display image (e.g., as illustrated in FIG. 3). Alternatively data processor 15 (FIG. 1) executes stored executable procedures to identify incorrect records and error processor 23 inserts data identifying incorrect records (data objects) in the smsdss.RptJobBypassObj table (e.g., Table I) in repository 17. In step 446 a worker restarts analytic report processor 39 to perform the batch processing. In step 451 processor 39 processes record data in the smsdss.RptJobBypassObj table in repository 17 to provide a work list and report for one or more workers to investigate and resolve. Data processor 15 in step 449 employs a qualification advantageously added to source code comprising individual fact load stored procedures that are associated with the table in repository 17 and automatically excludes objects identified as incorrect in the table in repository 17 during load of report data from operational store 32.

The system enables complex business reports to be generated when invalid data conditions occur and allows complex, time critical reports to be generated, even when data errors exist. The system also identifies incorrect database conditions and creates a worklist for a user to indicate to the user problems to correct. This technique could be applied to any database application or data warehousing application

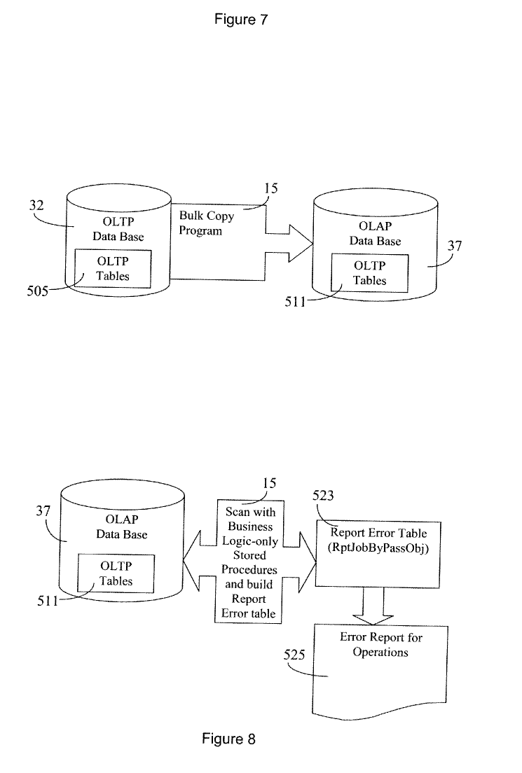

FIG. 7-9 illustrate steps in processing data objects causing report generation errors performed by data processor 15 (FIGS. 1 and 7-9). FIG. 7 illustrates bulk copying of tables 505 in Online Transaction Processing (OLTP) database 32 into tables 511 in Online Analytic Processing (OLAP) database 37 by an executable copying procedure in data processor 15 without any modification. FIG. 8 illustrates scanning OLTP tables for error conditions. Data processor 15 scans copied OLTP tables 511 in database 37 using business logic that is applied to build a set of production data marts. This scanning operation does not build the data mart, but identifies data conditions that cause data mart build to fail. Processor 15 in step 523 adds data indicating records that will cause failure to smsdss.RptJobBypassObj table. Error processor 23 (FIG. 1) generates a report in step 525 for analysis and use by workers to determine causes of errors.

Code employed by data processor 15 for scanning Patient Diagnosis OLTP tables 511 in database 37 prior to production load of a data mart comprises, for example,

Insert smsdss.RptJobBypassObj
select TrgObjId from dbo.PtDx PtDxEnc
group by TrgObjId,SeqNo,DxTypeCd,TrgTypeCd having count(*) >1

This code detects duplicate data prior to production load of a data mart and identifies this bad duplicate data likely to cause failure of generation of a report for exclusion using duplicate data identifiers contained in the smsdss.RptJobBypassObj table. This advantageously prevents abnormal termination of a data transfer and load operation. The code comprises an insert statement and scans source OLTP tables 511 in database 37 where duplicates may exist and creates a list identifying duplicate ObjId's that looks as follows, for example.

| TrgObjId | Count |
|---|---|
| 1043216884 | 1 |
| 1043218286 | 2 |
| 1043223270 | 1 |
| 1043223686 | 2 |
| 1043230664 | 1 |
| 1043231013 | 4 |
| 1043247624 | 3 |
| 1043248010 | 1 |
| 1043248407 | 1 |
| 1043248737 | 2 |

The code identifies those objid's with count greater than 1 (i.e., duplicates objid's), and inserts data indicating the duplicate objid's into the smsdss.RptJobByPassObj table. As long as those objid's identified as duplicates exist in the smsdss.RptJobByPassObj table, data processor 15 bypasses and excludes them from a fact table load and prevents abnormal termination of a report generation operation, for example.

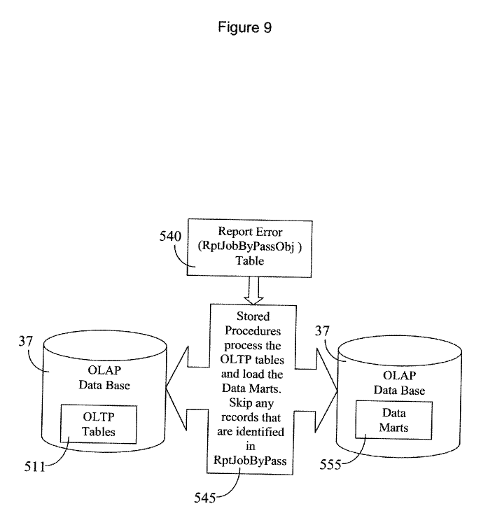

FIG. 9 shows a process for loading data marts. Data processor 15 processes and loads copied OLTP tables 511 in database 37 to data marts 555 in OLAP database 37 by bypassing records identified in the smsdss.RptJobBypassObj table. Specifically, data processor 15 in step 540 examines the smsdss.RptJobBypassObj table to determine if particular record keys are present in the table. If a particular record key is present in the table, the associated record is bypassed and not transferred from tables 511 to data marts 555 in database 37 by data processor 15 in step 545. Code employed by data processor 15 for scanning Patient Diagnosis OLTP tables 511 in database 37, checking the smsdss.RptJobBypassObj table for records to be bypassed and loading data marts 555 in OLAP database 37 with good data comprises, for example,

Select data columns
from dbo.vw_PtDx f
left join smsdss.EncFct d1 on
f.EncCommonDataObjId = d1.EncCommonDataObjId and
(d1.EncObjId = (select top 1 x.EncObjId from smsdss.EncFct
x where x.EncCommonDataObjId = d1.EncCommonDataObjId order
by x.RptEncStrDate desc))
left join smsdss.EncFct d2 on
f.EncObjId = d2.EncObjId
where (f.ObjId not in (select a.ByPassObjId from
smsdss.RptJobBypassObj a where a.TrgTable =
’smsdss.DxProcFct‘ and a.PassSeqNo = 1 and a.RslvDate
is null))

In one embodiment data processor 15 applies corrective action comprising skipping duplicate data and reporting it to appropriate personnel for deletion or fixing to prevent it being considered duplication. In another embodiment, data processor 15 automatically detects duplicate data (e.g., before a nightly report batch processing operation) and automatically skips the duplicate data, deletes the duplicate data if possible or corrects the duplicate data. The system allows complex reports to be created when invalid data conditions occur and when data errors exist. The system also identifies incorrect database conditions and creates a work list for a worker indicating data errors to be corrected by the worker. The system isolates an analysis and reporting database (used for generating reports) from errors, and provides feedback to a transaction processing system indicating data integrity problems that may potentially impact the reporting system.

FIG. 10 shows a flowchart of a process performed by system 10 for validating data for processing and incorporation in a report. In step 912 following the start at step 911, data processor 15 acquires and copies report data from a data source and stores the report data in a first repository, (operational data store 32) e.g., an Online Transaction Processing database. In step 915, data processor 15 processes and parses report data in the first repository to identify data objects likely to generate errors (such as replicate data objects) during preparation of a report based on the report data. Data processor 15, in step 917, generates a second repository (repository 17) of error information indicating identified data objects (e.g., replicate data objects) in the first repository likely to generate errors. In step 919, data processor 15, using Extract, Transform, Load (ETL) executable procedures 19, transfers report data from the first repository to a validated report data repository (database 37, such as an Online Analytic Processing database) by excluding data objects from transfer indicated as data objects likely to generate errors in the second repository. Data processor 15 provides validated report data by collating received report data and omitting the identified data objects likely to generate errors and communicates the validated report data for storage in the validated report data repository for use in preparation of a report. The first repository, the second repository and the validated data repository comprise one or more databases. Data processor 15 performs a data integrity check on data during transferring the report data from the first repository to the validated report data repository.

In step 921, error processor 23 provides summary information indicating identified data objects in the error information likely to generate errors and a corresponding reason an individual data object is likely to cause an error. In one embodiment error processor 23 makes corrective actions including deleting a duplicate record or correcting bad data based on a set of business rules. Error data processor 23 includes in the summary information, at least one of, (a) a date of detection of the data objects in the report data likely to generate errors and (b) a date of resolution of an error associated with an individual identified data object. In step 926, data processor 15 searches the error information to find one or more data objects indicated as likely to generate errors during preparation of a report in response to user entered text. In step 928, analytic report processor 39 (a report generator) generates a report using data in the validated report data repository. The process of FIG. 10 terminates at step 929.

The systems and processes of FIGS. 1-10 are not exclusive. Other systems, processes and menus may be derived in accordance with the principles of the invention to accomplish the same objectives. Although this invention has been described with reference to particular embodiments, it is to be understood that the embodiments and variations shown and described herein are for illustration purposes only. Modifications to the current design may be implemented by those skilled in the art, without departing from the scope of the invention. In one embodiment, the system makes a copy of online transaction tables. In another embodiment that does not make a copy, corrective actions including deleting a duplicate record or correcting bad data based on a set of business rules are incorporated. The processes and applications may, in alternative embodiments, be located on one or more (e.g., distributed) processing devices accessing a network linking the elements of FIG. 1. Further, any of the functions and steps provided in FIGS. 1-10 may be implemented in hardware, software or a combination of both and may reside on one or more processing devices located at any location of a network linking the elements of FIG. 1 or another linked network, including the Internet.

What is claimed is:

1. A system for processing data for incorporation in a report, comprising:
a data processor for,
acquiring report data by,
processing received report data to identify data objects in said report data, said data objects being likely to generate errors in preparation of a report based on said report data;
providing validated report data by collating received report data and omitting identified data objects likely to generate errors and
communicating said validated report data for storage in a repository for use in preparation of a report; and
an error data processor for providing information indicating identified data objects in said report data likely to generate errors and a corresponding reason an individual data object is likely to cause an error.

2. A system according to claim 1, wherein
said data processor uses said information indicating identified data objects likely to generate errors, to identify data objects in said report data and omit identified data objects likely to generate errors from said validated report data derived from said report data.

3. A system according to claim 2, wherein
said data objects in said report data likely to generate errors in preparation of a report comprise replicated data objects.

4. A system according to claim 1, wherein
said error data processor provides information indicating identified data objects in said report data likely to generate errors and a date of detection of said data objects in said report data likely to generate errors.

5. A system according to claim 1, wherein
said error data processor provides information indicating identified data objects in said report data likely to generate errors and a date of resolution of an error associated with an individual identified data object.

6. A system for processing data for incorporation in a report, comprising:
a first repository of report data;
a data processor for,
parsing report data in said first repository to identify data objects likely to generate errors during preparation of a report based on said report data,
generating a second repository of error information indicating identified data objects in said first repository likely to generate errors,
transferring report data from said first repository to a validated report data repository by excluding data objects from transfer indicated as data objects likely to generate errors in said second repository; and
an error data processor for providing summary information indicating identified data objects in said error information and a corresponding reason an individual data object is likely to cause an error.

7. A system according to claim 6, wherein
said data processor copies said report data from a data source for storage in said first repository.

8. A system according to claim 6, wherein
said error data processor includes in said summary information, at least one of, (a) a date of detection of said data objects in said report data likely to generate errors and (b) a date of resolution of an error associated with an individual identified data object.

9. A system according to claim 6, including
a search processor for searching said error information to find one or more data objects indicated as likely to generate errors during preparation of a report in response to user entered text.

10. A system according to claim 6, wherein
said data processor performs a data integrity check on data during transferring said report data from said first repository to said validated report data repository.

11. A system for processing data for incorporation in a report comprising:
a first repository of report data;
a data processor for,
parsing report data in said first repository to identify replicate data objects likely to generate errors during preparation of a report based on said report data,
generating a second repository of error information indicating identified replicate data objects in said first repository likely to generate errors,
transferring report data from said first repository to a validated report data repository by excluding replicate data objects from transfer indicated as replicate data objects in said second repository; and
a report generator for generating a report using data in said validated report data repository.

12. A system according to claim 11, wherein
said first repository is an Online Transaction Processing database.

13. A system according to claim 11, wherein
said validated report data repository is an Online Analytic Processing database.

14. A system according to claim 11, wherein
said first repository, said second repository and said validated data repository comprise one or more databases.
